(19) United States
(12) Patent Application Publication
(10) Pub. No.: US 2004/0120475 A1
(43) Pub. Date: Jun. 24, 2004

(54) Method and apparatus for receiving a message on a prepaid card or calling card

(76) Inventors: Thomas Michael Bauer, Belle Mead, NJ (US); Amit Garg, Freehold, NJ (US); Rajeev B. Patil, Holmdel, NJ (US)

Correspondence Address: Vernon Williams, Benman, Brown & Williams, P.O. Box 941385, Plano, TX, 75094, US

(21) Appl. No.: 10/326,323

(22) Filed: Dec. 20, 2002

(51) Int. Cl. H04M 11/00

(52) U.S. Cl. 379/88.18

(57) ABSTRACT

A method and apparatus for storing and retrieving voicemail with a calling card is presented. A calling card is implemented with at least two personal identification numbers (PINs). A calling-card platform prompts a calling-card user to enter a PIN number. If a first PIN number is entered, options are presented that enable the calling-card user to record a voice message greeting, record a voicemail, retrieve a voicemail left by a caller, complete a call, or access account information. If a second PIN number is entered, the call is switched to a voice-messaging platform. At the voice-messaging platform, the calling-card user is prompted to record a voicemail message for the calling-card owner.

### BACKGROUND OF THE INVENTION

1. Field of the Invention

The present invention relates to communications. Specifically, the present invention relates to calling cards.

2. Description of the Related Art

In conventional telephone systems, a calling party accesses a telephone and initiates a call using the telephone (i.e., calling telephone). The call is switched across a network to a called party (i.e., call recipient). The call is billed to an account associated with the calling telephone.

However, as callers became more mobile, there was a need for a new method of initiating calls so that calls are billed to the calling party, not the calling telephone. As such, calling cards were implemented. Using a calling card, a caller could access any telephone, enter a predefined number and account number, and the call would be billed based on the account number rather than the number of the calling telephone. As a result, a calling party could make a call from any telephone (i.e., location) and have the call charged back to the calling party (i.e., caller account) rather than the calling telephone.

When using a calling card, a calling party typically enters at least three numbers: a predefined number that switches the calling party to a calling-card platform, the number of the called party, and an account number, such as a personal identification number (PIN). The calling-card platform is typically implemented with a circuit switch that is associated with a database. The circuit switch switches the call from the calling party to the called party. The PIN and the account number of the calling party are stored and correlated in a database. As such, the call may be charged to the account of the calling party rather than the account associated with the calling telephone.

The ability to separate the billing of a call from the technology making the call (i.e., calling telephone) opened up new opportunities for service providers. For example, calling cards could be associated with credits for making a call. These calling cards are known as prepaid calling cards. A prepaid calling card is a calling card, which has a certain amount of calling time (i.e., credit) associated with the card. For example, a prepaid calling card may come in different financial denominations, such as $5, $50, $100, etc. By buying a prepaid calling card, the caller pays for the calls in advance (i.e., at the time of purchase). The account number associated with the prepaid calling card continues to operate until the value on the prepaid calling card is debited to zero value. Once the value on the prepaid calling card is debited to zero value, the calling party has to replace the prepaid calling card to make calls.

In addition to prepaid calling cards that have a static value associated with the card, there are calling cards or prepaid calling cards where a value may be added to the card (i.e., placed on the card). As such, a calling party may pay for a certain amount of call time in advance and then use the call time until the value placed on the card is depleted. Once the call time has been depleted, the calling party may then add more call time to the calling card and repeat the process.

As calling cards become more ubiquitous and widely used, customers look for the same calling services when making a call with a calling card as when making a call with a traditional telephone. For example, customers expect the same variety of services when making a call with a calling card as when making a call with a conventional telephone system. However, not every service that is provided in a conventional telephone system is implemented when using a calling card or prepaid calling card. This contributes to the fact that, calling cards are not as widely deployed as the conventional telephone.

Thus, there is a need in the art for a method and apparatus that implements traditional telephone services when using a calling card. There is a need in the art for a method and apparatus that implements traditional telephone services when using a prepaid calling card. There is a need for a method and apparatus that will facilitate the wide deployment and use of calling cards.

### SUMMARY OF THE INVENTION

The present invention is directed to a method and apparatus for implementing telephone services when using a calling card. In one embodiment of the present invention, a method and apparatus is presented for implementing voicemail services when using a calling card, a prepaid calling card, or another identification and payment vehicle.

In one embodiment of the present invention, a method and apparatus is presented for recording voicemail messages for a calling-card owner. A method and apparatus is presented for processing voicemail messages (i.e., accessing, retrieving, deleting, etc.) when using a calling card. The method and apparatus of the present invention prompts the calling-card owner with a new voicemail indication and gives the calling-card owner the option of processing the new voicemail or proceeding with a call.

The method and apparatus of the present invention may be implemented with a calling card, a prepaid calling card, a virtual calling card, a commercial credit card, or a home telephone bill as the identification and payment vehicle. Alternative embodiments of the present invention may be used by calling-card users that currently have traditional telephone service, calling-card users that are in professions that require mobility, calling-card users with calling-card service, college students, military personnel, sales personnel, truckers, calling-card users that need voicemail service independent of their home or office lines, calling-card users without telephone service, etc.

In one embodiment of the present invention, a system comprises a database storing a unique identifier. The database stores a first personal identification n u m b e r (PIN) associated with the unique identifier and a second personal identification n u m b e r associated with the unique identifier. In one embodiment of the present invention, the unique identifier is associated with a calling-card owner and identifies the calling-card owner. The first personal identification number is associated with calling-card services available to the calling-card owner and the second personal identification number is associated with calling-card services available to a caller that would like to leave a voicemail for the calling-card owner.

A first platform is coupled to the database; the first platform receives an incoming call from a calling-card user. The calling-card user may be a caller or a calling-card owner. In one embodiment of the present invention, the first platform is a calling-card platform. The first platform receives the incoming call and plays a prerecorded greeting (i.e., prompt). The calling-card user enters a personal identification number in response to the prompt and the first platform receives the personal identification number (i.e., first or second). The first platform then processes the call or switches the call to a second platform in response to receiving the personal identification number. The second platform is also coupled to the database. In one embodiment of the present invention, the second platform is a voice-messaging platform. The second platform plays a prerecorded greeting (i.e., prompt), which provides voicemail options to the calling-card user.

In one method of the present invention, by entering the first personal identification number, the calling-card owner may access calling-card services on the first platform or be switched to the second platform and access calling-card services on the second platform, such as voicemail recording, voicemail retrieval, etc. In a second method of the present invention, a caller may enter the second personal identification number. Once the first platform receives the second personal identification number, the call is switched to the second platform so that the caller can access calling-card services on the second platform, such as a voicemail recording service (i.e., to record a voicemail for the calling-card owner). In an alternative embodiment of the present invention, the second personal identification number may be associated with a separate dialing number, such as a different toll-free number. As a result, the call would terminate on the second platform, which would make the initial prompt for the second personal identification number. Upon valid entry of the second personal identification number, the second platform would prompt the caller to record a message for the calling-card owner.

In one embodiment of the present invention, a system comprises a database storing a unique identifier associated with a calling-card account, the calling-card account including calling-card services, a first personal identification number associated with the unique identifier and capable of providing access to the calling services, a second personal identification number associated with the unique identifier and capable of providing access to a subset of the calling-card services; a first platform coupled to the database, the first platform accessing the database and enabling the calling-card services in response to the first personal identification number and the first platform accessing the database and enabling the subset of the calling services in response to the second personal identification number; and a second platform coupled to the first platform, the second platform providing the subset of the calling-card services.

A system comprises a database storing a unique identifier associated with a calling-card account, the calling-card account associated with calling-card services, a first personal identification number associated with the unique identifier and enabling access to the calling-card services, a second personal identification number associated with the unique identifier and enabling access to a subset of the calling-card services; a first platform coupled to the database, the first platform accessing the database and enabling the calling-card services in response to the first personal identification number and the first platform accessing the database and enabling the subset of the calling services in response to the second personal identification number; and a second platform coupled to the database, the second platform accessing the database and enabling the calling-card services in response to the first personal identification number and the second platform accessing the database and enabling the subset of the calling services in response to the second personal identification number.

A method of operating a system comprises the steps of receiving a call initiated using a calling-card account; playing a recorded message in response to receiving the call; receiving a personal identification number in response to playing the recorded message; authenticating the personal identification number; and switching the call to a messaging platform capable of recording a voicemail.

A method of operating a system comprises the steps of receiving a call; playing a first recorded message requesting a personal identification number in response to receiving the call; receiving the personal identification number in response to playing the first recorded message requesting the personal identification number; playing a second recorded message, the second recorded message indicating that a voicemail message is available in response to receiving the personal identification number and the second recorded message further providing caller options, in response to receiving the personal identification number; receiving an input indicating selection of one of the caller options; and switching the call to a messaging platform, where the messaging platform plays the voicemail in response to receiving the selection of one of the caller options and in response to the personal identification number.

A calling card comprises a first personal identification number associated with the calling card, the first personal identification number enabling first services; and a second personal identification number associated with the calling card, the second personal identification number enabling second services.

### BRIEF DESCRIPTION OF THE DRAWINGS

FIG. 1 displays a network architecture implementing the method and apparatus of the present invention.

FIG. 2 displays a flow diagram of a caller method implemented by the network shown in FIG. 1.

FIG. 3 displays a flow diagram of a calling-card owner method implemented by the network shown in FIG. 1.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In a method and apparatus of the present invention, voicemail is implemented when using a calling card. For the purposes of discussion, the term “calling card” is used throughout the application. However, a “calling card” may represent any type of identification and payment vehicle, such as a calling card, a prepaid calling card, a virtual calling card, commercial credit card, or a home phone bill.

Two types of calling-card users are identified. The first calling-card user is a calling-card owner. The calling-card owner is any individual or entity that is responsible for the account associated with the calling card. In one embodiment of the present invention, the calling-card owner may use the calling card to make calls, to record message greetings, to record a message (i.e., a voicemail for the calling-card owner), to process voicemail, or to process account information associated with the calling-card account. The second type of calling-card user is a caller. The caller is any calling-card user making a call. In one method of the present invention, the caller is given the option to record a voicemail for the calling-card owner.

An account is defined for the calling-card owner. The account is a unique identifier associated with the calling-card owner. In one embodiment of the present invention, two personal identification numbers are associated with each account. However, it should be appreciated that multiple personal identification numbers may be associated with the account and still remain within the scope of the present invention.

Calling-card services are defined in the present invention. Calling-card services include call processing services, voicemail processing services, account processing services, and any other services that are available with the use of a calling card implemented in accordance with the teachings of the present invention. Call processing services include any method or apparatus used in performing call processing. Voicemail processing services include any method and apparatus used in performing voicemail processing. Account processing services include any method or apparatus required to process calling-card account information, where calling-card account information is any information associated with a calling-card user.

In one embodiment of the present invention, the first personal identification number is associated with the calling-card owner and enables the calling-card owner to access all of the calling-card services (i.e., functionality) provided by the calling-card platform and voice-messaging platform. In one embodiment of the present invention, calling-card services accessible with the first PIN include call processing services, voicemail processing services and account processing services. However, it should be appreciated that other calling-card services may be enabled. Call processing services may include any process or apparatus required to manage/process a call. Voicemail processing services may include any process or apparatus required to manage/process voicemail. Account processing services may include any process or apparatus required to manage/process account information. For example, call processing services may include the completion of a call to a called party, etc. Voicemail processing services may include recording, deleting and changing voicemail greetings; access, retrieval and deletion of voicemail; access, retrieval, deletion and change of voicemail account information, etc. Account processing services may include accessing account information, updating account information, etc.

The second personal identification number associated with the account provides access to a subset of the calling-card services enabled by the calling-card platform and voice-messaging platform. In one embodiment of the present invention, the second personal identification number is associated with a caller and enables the caller to access the subset of the calling-card services (i.e., functionality) provided by the calling-card platform and voice-messaging platform. In one embodiment of the present invention, the second PIN would enable a caller to access voicemail processing services. In a second embodiment of the present invention, the second PIN would enable the caller to access a subset of the voicemail processing services. The subset of the voicemail processing services may include the voicemail processing services required to leave a voicemail for the calling-card owner.

The two PINs may give calling-card users access to a variety of different types of services. In an alternate embodiment of the present invention, the two PINs may provide two calling-card users with access to two different types of services. For example, a parent (i.e., calling-card owner) may provide a calling card to a child (i.e., caller). In one embodiment of the present invention, the parent may have one PIN and the child may have a second PIN. The first PIN may enable the parent to make international calls while the second PIN may only enable domestic calls. In another example, the first PIN may enable the parent to make unlimited calls while the second PIN, used by the child, may only be valid for a limited amount of calls. It should be appreciated that a variety of different types and levels of services may be implemented and associated with different PINs.

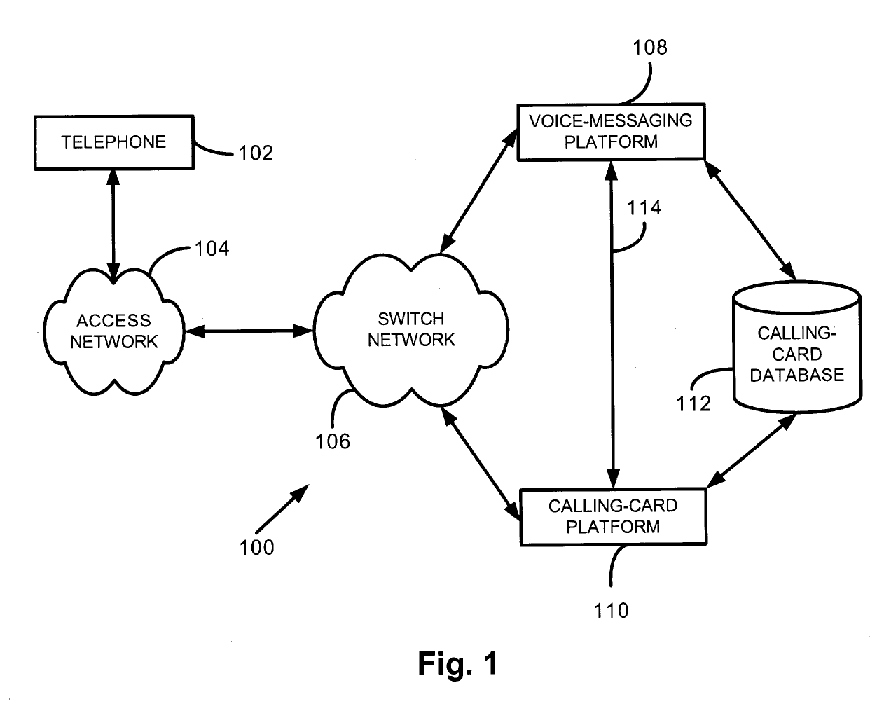

FIG. 1 displays an embodiment of a network implementing a method and apparatus of the present invention. A caller accesses a network using a telephone 102. The telephone 102 is in communication with an access network 104, which is in communication with a switch network 106. The switch network 106 is in communication with a voice-messaging platform 108 and a calling-card platform 110. The voice-messaging platform 108 and the calling-card platform 110 both access a calling-card database 112. Calls are switched between the calling-card platform 110 and the voice-messaging platform 108 through an interface 114.

The telephone 102 enables a caller or a calling-card owner to make a call using the calling card. The telephone 102 may be a terrestrial telephone (i.e., analog, digital) or a wireless telephone. Further, the telephone 102 may be a private telephone or the telephone 102 may be a public telephone.

An access network 104 is connected to the telephone 102. The access network 104 may be implemented with a variety of technologies, such as a server, Private-Branch Exchange (PBX), Digital Subscription Line (DSL), etc. The access network 104 provides a connection between the telephone 102 and the switch network 106.

The switch network 106 may be a circuit-switch network or a packet-switch network. For example, the switch network 106 may be a circuit-switch network connecting callers using a telephone 102 with a virtual circuit connection to the voice-messaging platform 108 or the calling-card platform 110. As such, in one embodiment of the present invention, the switch network 106 may be a public service telephone network (PSTN). The switch network 106 may be a packet-switch network communicating packets from a caller using a telephone 102 to the voice-messaging platform 108 and/or the calling-card platform 110. As such, the switch network 106 may be implemented with softswitch technology.

The telephone 102, the access network 104, the switch network 106, the calling-card platform 110, the voice-messaging platform 108, and the calling-card database 112 may be implemented using a multi-function computer. It should be appreciated that, while the calling-card platform 110, the voice-messaging platform 108, and the calling-card database 112 are depicted in a networked configuration, each of these respective components may be combined into a single multi-function computer. In addition, any combination of components may be combined in a single multi-function computer while the remaining components are networked. In addition, it should be appreciated that the software and data associated with the calling-card platform 110; the voice-messaging platform 108, and the calling-card database 112 may each reside in a single multi-function computer or may be distributed among various networked computers. Further, in an alternative implementation, each component of the present invention may be implemented with specialized hardware.

The calling-card platform 110 performs call processing, voicemail processing (i.e., switching voicemail calls or new message notification), calling-card user (i.e., caller and calling-card owner) authentication, and billing for calls associated with a calling card. A number of calling-card services are implemented using the calling-card platform 110. For example, the calling-card platform 110 includes the methods and apparatus required to provide a calling-card user, such as a caller or calling-card owner, with calling-card services, such as call processing services, voicemail processing services, account processing services, or an alternative service that may be implemented with a calling card. In one embodiment of the present invention, the calling-card platform 110 enables call processing by completing a call initiated with a calling card. In a second embodiment of the present invention, the calling-card platform 110 enables voicemail processing by switching a call to the voice-messaging platform 108 for voice mail processing. In another embodiment of the present invention, the calling-card platform 110 enables account information processing by accessing the calling-card database 112 for calling-card owner account information.

The calling-card platform 110 may include a number of methods (i.e., applications) implemented with computer instructions. The methods enable the calling-card platform 110 to provide calling-card services to callers and the calling-card owner. For example, a subset of the methods required for operation, such as a call detail record (CDR) method, a matching method, a rating method, a billing method, an invoicing method, and an accounting method are implemented in the calling-card platform 110. All of these methods produce account information that may be stored in the calling-card database 112.

The CDR method collects data, such as the start time of a call, the end time of the call, duration of the call, originating number, and terminating number. The matching method may match the caller to a customer-calling plan for the purposes of billing. In one embodiment of the present invention, the matching method uses the start time of the call, the end time of the call, the duration of the call, and the time of the call to decide the charge for the call. The rating method gives the call a monetary or financial value that will be charged based on the matching method. For example, the call may be charged at a rate of 20 cents per minute. The billing method collects all of the calls that have been rated and stored over a period of time, such as 30 days. The billing method may take into account promotion and discounts that are associated with the calling-card owner's account. For example, if the call exceeded a certain period of time, a volume discount may be applied. In addition, the billing method applies taxes and credits. Lastly, the invoicing method collects the customer's information for invoicing. For example, paper invoices may be created or electronic statements may be created using the invoicing method. In addition, the invoices may be stored (i.e., in a database) when using the invoicing method.

An accounting method may be implemented in the calling-card platform 110. The accounting method may provide for the checking and debiting of account balances. As such, the calling-card owner would be able to access the calling-card platform 110 and either speak or provide numerical codes into the calling-card platform 110 for checking account information, such as account balances. In addition, various credit and debit charges may be associated with the use of the calling card. The accounting method may be used to debit or credit charges to the calling-card account. In the case of a prepaid calling card, the accounting method may be used to debit the account balance on the prepaid calling card when voice messages are recorded on the voice-messaging platform 108. In one embodiment of the present invention, the accounting method operates by accessing the calling-card database 112 and crediting or debiting various fields within the calling-card database 112 that are associated with the operation of the voice-messaging platform 108.

Crediting, debiting or checking on a calling-card account may occur at anytime. For example, the checking and/or editing of account information may occur prior to recording a message in order to verify that the appropriate account balance (i.e., credit) is available to leave a voicemail. In another embodiment, the checking and/or debiting of an account balance may be accomplished after a voicemail is recorded (i.e., when the calling-card account is associated with a monthly billing statements as opposed to a prepaid account).

It should be appreciated that the foregoing methods are illustrative. A number of alternative methods may be implemented and still remain within the scope of the present invention. For example, an alternative set of methods may be implemented with a prepaid calling card or when a credit card is used and still remain within the scope of the present invention.

An interface 114 is provided between the calling-card platform 110 and the voice-message platform 108. The interface 114 may be a direct connection, such as a cable connection between the calling-card platform 110 and the voice-messaging platform 108. In an alternative embodiment, the interface 114 may be a network connection in which the calling-card platform 110 communicates with the voice-messaging platform 108 across a communication network, such as a Local Area Network (LAN) or a Wide Area Network (WAN). Once a PIN associated with the voicemail service is received by the calling-card platform 110, a call is switched from the calling-card platform 110 to the voice-messaging server 108. The call may be switched from the calling-card platform 110 to the voice-messaging platform 108 using existing capabilities of the switch network 106 or using the interface 114.

In another embodiment of the present invention, the interface 114 is a telephony interface, which includes telephone signaling and management. As such, a call may be switched from the calling-card platform 110 to the voice-messaging platform 108 without the call being dropped. The telephone signaling and management may be implemented with the SS7 protocol if the interface 114 is a circuit-switched interface. In addition, the telephone signaling and management may be accomplished with a variety of packet-switching protocols (i.e., Megaco, H.323, Session Initiation Protocol (SIP), etc.) when the interface 114 is a packet-switch interface.

The voice-messaging platform 108 provides voicemail and account processing services. Using the voice-messaging platform 108, a caller may record a voicemail; the calling-card owner may record voicemail greetings; the calling-card owner may record voicemail; or the calling-card owner may perform other functions, such as accessing account information, retrieving voicemail, deleting voicemail, etc.

A number of calling-card services are implemented using the voice-messaging platform 108. For example, the voice-messaging platform 108 includes the methods and apparatus required to provide a calling-card user, such as a caller or calling-card owner, with calling-card services, such as voicemail processing or alternative services that may be implemented with a calling card. The voice-messaging platform 108 enables calling-card services, such as the recording, retrieval and deletion of voicemail by the calling-card owner and the recording of voicemail by the caller. In addition, in one embodiment of the present invention, the calling-card owner may record voicemail greetings using the voice-messaging platform 108. In another embodiment of the present invention, the calling-card owner may access voicemail account information using the voice-messaging platform 108. Voicemail account information may include any information associated with a voicemail.

The voice-messaging platform 108 includes storage capability. For example, the voice-messaging platform 108 may include a storage disk for storing voicemail as digital recordings. In addition, the voice-messaging platform 108 may be connected to a storage unit for storing voicemail as analog recordings. In addition, the voice-messaging platform 108 includes interfaces for connecting to the calling-card platform 110 and the switch network 106.

A variety of different methods or processes are implemented on the voice-messaging platform 108. The methods or processes may be implemented with computer instructions or with computer logic. For example, a calling-card user interface method, a method of updating and providing message status, and a message-deletion method may be implemented in the voice-messaging platform 108.

A calling-card user interface method is a method implemented in both the voice-messaging platform 108 and the calling-card platform 110. The calling-card user interface method enables a calling-card owner or a caller to interface with the voice-messaging platform 108 and the calling-card platform 110. The calling-card user interface method may be implemented with a variety of user interface technologies. For example, dual tone multi-frequency (DTMF) technology may be used as a user interface technology. Voice recognition may be used as an interface technology. Natural language processing may be used as an interface technology.

A method of updating and providing voicemail message status is implemented in the voice-messaging platform 108. In one embodiment of the present invention, the method for updating and providing message status accesses the calling-card database 112 to update various account fields associated with voicemail stored on the voice-messaging platform 108. The calling-card database 112 may include fields that characterize the voicemail messages or fields associated with the processing of the voicemail messages. For example, the calling-card database 112 may include fields associated with the number of recorded voicemail messages, the originating number associated with the voicemail messages, the initiating time of the voicemail messages, the concluding time of the voicemail messages, the duration of the voicemail messages, etc. As the voicemail messages are processed, the method of updating and providing voicemail message status accesses the calling-card database 112 and updates these various fields within the calling-card database 112. The method for updating and providing voicemail message status then provides the status of voicemail messages when the calling-card owner accesses the calling-card platform 110.

A message-deletion method may operate within the voice-messaging server 108. The message-deletion method may direct the deletion of recorded voicemail messages based on a predefined algorithm. For example, a predefined algorithm may define that messages are deleted “X” number of days after recording or “Y” number of days after the invoicing method has been performed. In a more sophisticated method, the message-deletion method may calculate “X” and calculate “Y” at a specific time and delete messages based on the greater of the two. It should be appreciated that a large variety of predefined algorithms may be implemented and remain within the scope of the present invention.

A calling-card database 112 is provided in the present invention. The calling-card database 112 stores a variety of different types of account information associated with the calling-card owner, callers, and the calling-card services. The calling-card database 112 may be implemented in a multi-function computer directly connected to the calling-card platform 110 or directly connected to the voice-messaging platform 108. In the alternative, the calling-card database 112 may be implemented in a multi-function computer remotely connected to the calling-card platform 110 or voice-messaging platform 108. In addition, the calling-card database 112 may be implemented with a relational database. As such, data stored in the calling-card database 112 may be correlated and searched.

Calling-card owner information may be stored in the calling-card database 112. The calling-card owner information may include account information, such as a unique identifier associated with the account of the calling-card owner. The calling-card account information may be linked to PINs. For example, in one embodiment of the present invention, two PINs are associated with the account information of the calling-card owner. The first PIN gives the calling-card owner access to all the calling-card services and operation. The second PIN gives the caller access to the voice-messaging platform 108 so that the caller can record voicemail for the calling-card owner. In addition, several other PINs may be associated with the account information of the calling-card owner. The other PINs may be used for a variety of reasons. For example, other PINs may be used to create classes of calling-card users with different access privileges.

A variety of other types of account information may be included in the calling-card database 112. For example, address information, type of calling-plan information, initiation and termination times of individual calls, the number of voice messages left, credit balances, etc. may be considered account information. It should be appreciated that, in the method and apparatus of the present invention, any type of information associated with the calling-card owner may be stored in the calling-card database 112. In addition, any type of information associated with call processing services, voicemail processing services, and account processing services may be stored in the calling-card database 112. For example, information indicating that a new voicemail is available for retrieval may be stored in the calling-card database 112, the type of voicemail may be stored in the calling-card database 112, the duration of the voicemail, the originating telephone number of a caller, the amount debited from a prepaid calling card, and any other information or data associated with the calling card initiated call (i.e., information on call processing services), voicemail (i.e., information on voicemail processing services) or account (i.e., information on account processing services) may be stored in the calling-card database 112.

In one embodiment of the present invention, the calling-card platform 110, the voice-messaging platform 108, and the calling card support two PIN numbers for each account. The calling-card platform 110 supports the first PIN number, which gives the calling-card owner access to all the calling-card services and operations. In addition, the calling-card platform 110 supports the second PIN, which gives a caller access to a subset of calling-card services so that the caller can record a message for the calling-card owner. Both, the first PIN and the second PIN are associated with the calling-card owner's account. The first PIN and the second PIN are stored in the database 112. Therefore, after receiving a call, the calling-card platform 110 accesses the calling-card database 112 to authenticate the PIN and then completes the call or switches the call to the voice-messaging platform 108, etc.

If the calling-card platform 110 receives the first PIN, which is typically entered by the calling-card owner, the calling-card owner receives a prompt informing the calling-card owner of new voice mail and options to place outbound calls. If the calling-card platform 110 receives the second PIN, the call is forwarded to the voice-messaging platform 108, which plays a greeting to the caller, prompting the caller to record a message for the calling-card owner.

In one embodiment of the present invention, a caller or a calling-card owner is able to select the various PIN numbers used in the system. For example, a calling-card owner has the flexibility to select a variety of types of PINs, such as a home telephone or a name. This provides a caller or calling-card owner with the freedom to customize their PINs, which may be easier for the caller or calling-card owner to remember. It should be appreciated that a wide variety of PIN numbers and types may be selected and still remain within the scope of the present invention.

In one embodiment, the method and apparatus of the present invention may be implemented with a prepaid calling card. During operation of a prepaid calling card implemented in accordance with teaching of the present invention, a caller records voicemail for a calling-card owner by using a predefined number to connect to a calling-card platform 110. The caller then enters a PIN number to access the voicemail. In one embodiment of the present invention, recording the voicemail will result in a debit to the prepaid calling card. The prepaid calling-card owner will be notified of the recorded message whenever the prepaid calling-card owner attempts to use the prepaid calling card. At that time, the prepaid calling-card owner will be given the option to retrieve the recorded message or to bypass the recorded message and complete a call.

A number of payment methods may be established when using the prepaid calling card. In one embodiment of the present invention, the prepaid calling-card owner is charged or their account debited based on the time of the voicemail. In another embodiment of the present invention, a static amount of credit may be debited each time a voicemail is recorded or retrieved. For example, ten minutes worth of credits may be debited every time a voicemail is recorded or retrieved. In another embodiment of the present invention, the account of the calling-card owner may be debited when the caller records the voicemail and the account may be debited again when the calling-card owner retrieves the voicemail. It should be appreciated that a wide variety of methods may be implemented for debiting and crediting the calling card and still remain within the scope of the present invention.

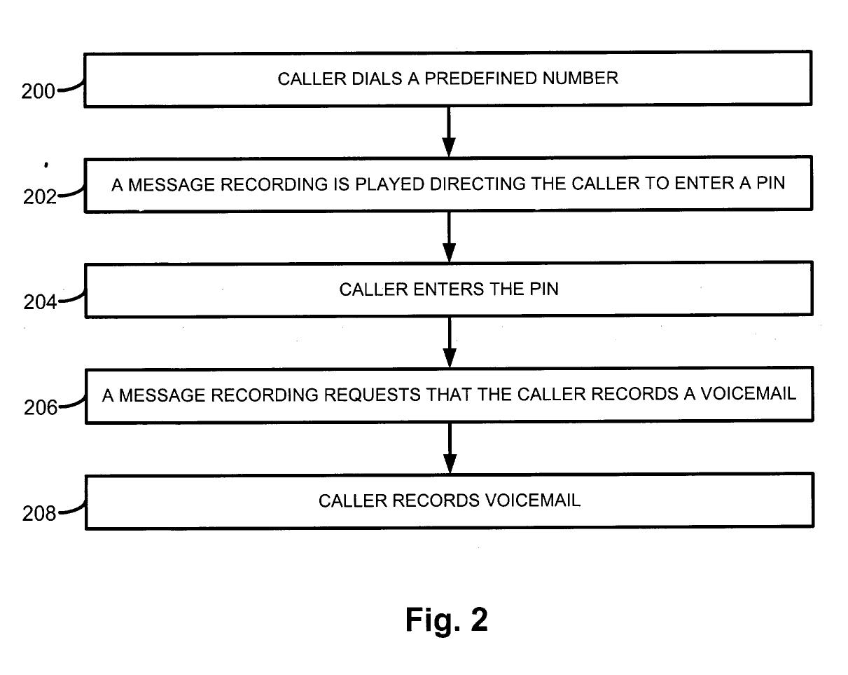

FIG. 2 displays a flowchart of a caller process implemented in one embodiment of the method and apparatus of the present invention. The flowchart of FIG. 2 will be discussed in conjunction with the network architecture depicted in FIG. 1. In one method of the present invention, a caller dials a predefined number from a telephone as shown at 200. By dialing the predefined number, the caller is connected to a calling-card platform 110 that performs user authentication and billing for the calling-card account. The predefined number establishes a communication path across the access network 104, across the switch network 106, to the calling-card platform 110. A message recording (i.e., prompt) is played which requests that the caller enters a personal identification number (PIN) as shown at 202. The message is a recording that is stored in the calling-card platform 110 and plays when the caller is connected to the calling-card platform 110. The caller then enters the PIN number as shown at 204. Once the calling-card platform 110 receives the PIN number, the calling-card platform 110 is able to associate the caller with a specific account where the caller may leave a voicemail. Once the PIN number is entered, call control is passed from the calling-card platform 110 to a voice-messaging platform 108. The voice-messaging platform 108 then plays (i.e., communicates) a message recording (i.e., prompt or a greeting) that request that the caller records a voicemail as shown at 206. The caller then records the voicemail on the voice-messaging platform 108 as shown at 208.

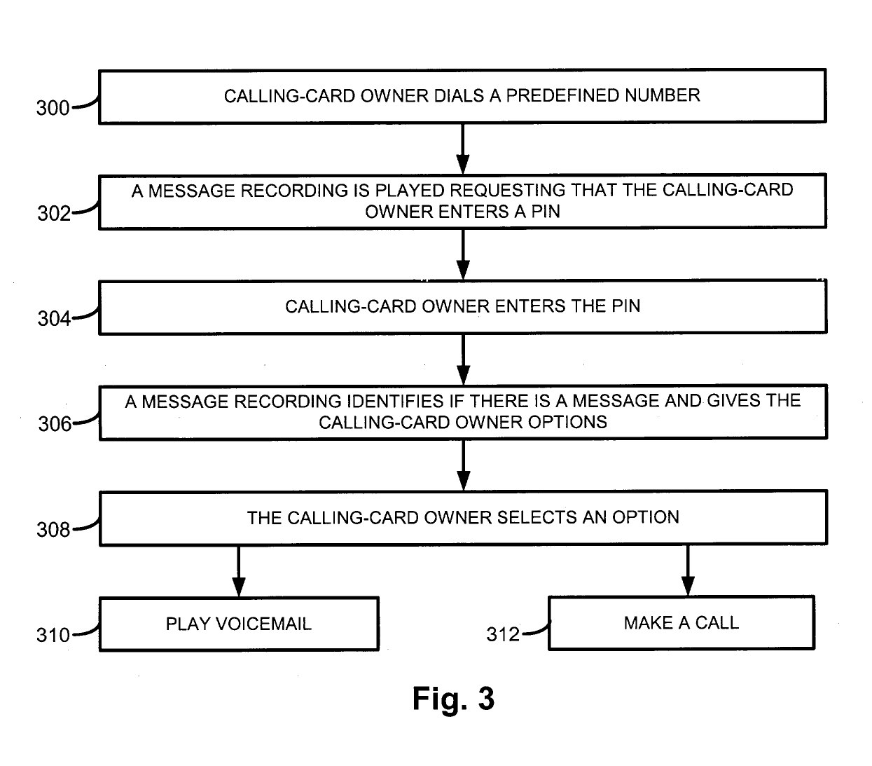

FIG. 3 displays a flowchart of a calling-card owner process implemented in one embodiment of the method and apparatus of the present invention. The flowchart of FIG. 3 will be discussed in conjunction with the network architecture depicted in FIG. 1. The calling-card owner uses a telephone to dial a predefined number associated with the calling card as shown at 300. Dialing the predefined number connects the calling-card owner to the calling-card platform 110. A message recording (i.e., prompt) stored on the calling-card platform 110 is played for the calling-card owner. The message recording requests that the calling-card owner enters a PIN number as shown at 302. The calling-card owner enters the PIN number into the telephone as shown at 304. The PIN number is received by the calling-card platform 110 and identifies the calling-card owner's account. Once the calling-card owner enters the PIN number, a message recording (i.e., prompt) stored on the calling-card platform 110 will notify the calling-card owner if a voicemail (i.e., new voicemail) is available for retrieval. If a new voicemail is stored on the voice-messaging platform 108 as shown at 306, the message-recording will then give the calling-card owner several options. For example, the message-recording may request that the calling-card owner “press 1” to retrieve the voicemail, “press 2” to bypass the voicemail and make a call, or “press 3” to disconnect. The calling-card owner then selects an option as shown at 308. In the alternative, the calling-card owner may decide to bypass the voicemail and make a call as shown at 312. If the calling-card owner selects option “1” to retrieve the voicemail, the calling-card platform 110 switches call control to the voice-messaging platform 108 where the voicemail is played for the calling-card owner or additional options are provided to the calling-card owner. For example, the calling-card owner may be given the option to retrieve voicemail account information, modify greetings, etc. If the calling-card owner selects the option to listen to the voicemail, the voice-messaging platform 108 plays a previously stored message (i.e., voicemail) as shown at 310.

Thus, the present invention has been described herein with reference to a particular embodiment for a particular application. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A system comprising:
a database storing a unique identifier associated with a calling card account, a first personal identification number associated with the unique identifier and enabling access to calling services, and a second personal identification number associated with the unique identifier and enabling access to a subset of the calling card services;
a first platform coupled to the database, the first platform accessing the database and enabling the calling card services in response to the first personal identification number and the first platform accessing the database and enabling the subset of the calling services in response to the second personal identification number; and
a second platform coupled to the database, the second platform accessing the database and enabling the calling card services in response to the first personal identification number and the second platform accessing the database and enabling the subset of the calling services in response to the second personal identification number.

2. A system as set forth in claim 1, wherein the first platform is a calling card platform.

3. A system as set forth in claim 1, wherein the second platform is a voice-messaging platform.

4. A system as set forth in claim 1, wherein the calling card services include call processing services and voicemail processing services.

5. A system as set forth in claim 1, wherein the subset of calling card services includes voicemail processing services.

6. A system as set forth in claim 1, wherein the first platform and the second platform are directly coupled.

7. A system as set forth in claim 1, wherein the first personal identification number is stored in the database.

8. A system as set forth in claim 1, wherein the second personal identification number is stored in the database.

9. A method of operating a system comprising the steps of:
receiving a call associated with a calling card account;
playing a recorded message in response to receiving the call;
receiving a personal identification number in response to playing the recorded message;
authenticating the personal identification number; and
switching the call to a messaging platform capable of recording a voicemail.

10. A method of operating a system as set forth in claim 9, wherein the recorded message is a prompt.

11. A method of operating a system comprising the steps of:
receiving a call initiated using a calling card account;
playing a first recorded message requesting a personal identification number in response to receiving the call;
receiving the personal identification number in response to playing the first recorded message requesting the personal identification number;
playing a second recorded message, the second recorded message indicating that a voicemail is available and providing caller options, in response to receiving the personal identification number;
receiving an input indicating selection of one of the caller options; and
switching the call to a messaging platform capable of playing the voicemail in response to receiving the input.

12. A method of operating a system as set forth in claim 11, wherein a caller option includes an option to make a call.

13. A method of operating a system as set forth in claim 11, wherein a caller option includes an option to process voicemail.

14. A method of operating a system as set forth in claim 11, wherein a caller option includes an option to process account information.

15. A calling card comprising:
a first personal identification number associated with the calling card, the first personal identification number enabling first services; and
a second personal identification number associated with the calling card, the second personal identification number enabling second services.

16. A calling card as set forth in claim 15, wherein the first services include call processing services and voicemail processing services and the second services include voicemail processing services.

17. A calling card as set forth in claim 15, wherein the first services include international calls and domestic calls and the second services include domestic calls.

18. A calling card as set forth in claim 15, wherein the first services include an unlimited number of calls and the second services include a limited number of calls.
